(19) United States
(12) Patent Application Publication
(10) Pub. No.: US 2002/0037697 A1
(43) Pub. Date: Mar. 28, 2002

(54) Ventilating structure

(76) Inventor: Satoshi Tokashiki, Naha (JP)

Correspondence Address: SATOSHI TOKASHIKI, MIHARA 1-10-40, NAHA, OKINAWA, 902-0063, JP

(21) Appl. No.: 09/953,377

(22) Filed: Sep. 10, 2001

(30) Foreign Application Priority Data
Mar. 16, 2000 (JP) PCT/JP00/01593

(51) Int. Cl. E06B 7/084; E06B 7/094; E06B 7/08

(52) U.S. Cl. 454/221; 49/80.1

(57) ABSTRACT

The Invention aims to provide a ventilation structure capable of interrupting a line of sight from the others while maintaining airflow.

The Invention is characterized in that indoor side plate material (5) and outdoor side plate material (3) are placed opposite each other, vertically traversing the ventilation space, with intermediate plate material (7) placed between the outdoor and indoor side plate materials; which structure is designed so that a line of light from one ventilation space will be interrupted by either the indoor side plate material or the intermediate plate material, and not to allow incoming light to pass through to the other ventilation space.

### TECHNICAL FIELD OF THE INVENTION

This invention relates to a ventilating structure capable of obstructing a line of sight from the others completely while maintaining adequate airflow.

### TECHNICAL BACKGROUND

Increasing urbanisation has led to higher concentrations of people in residential spaces. This, in turn, has made privacy a priority: While increasing use is being made of insulators and sealants in construction in order to reduce the amount of electricity used for heating and cooling and to increase energy efficiency, airtight homes require ventilation. However, opening windows to let in outside air sacrifices privacy. In addition, rain and the possibility of burglary present problems. While currently available ventilation structures do make it impossible to see inside from a distance, it remains possible to see inside diagonally from close up, and the top and bottom of the room in question often remain visible. They also offer no protection against rain. As a result their usefulness is limited to high windows.

It is possible to install ventilators in order to allow for ventilation without opening windows, but these tend to be quite costly. A simpler method is needed. There are some ventilation structures on the market that maintain airflow while protecting privacy (e.g. louvered windows). In light of the foregoing, the Invention addresses the problem of creating a ventilation structure that obstructs the view from outside while preserving airflow.

### DISCLOSURE OF THE INVENTION

In order to solve the above problem, the Invention places several indoor and outdoor side plate materials opposite each other, vertically traversing the ventilation space, with intermediate plate materials placed between the outdoor and indoor side plate materials. The structure is designed so that a ray of light from one ventilation space will be interrupted by either the indoor side plate material or the intermediate plate material, and not pass through to the other ventilation space. The above intermediate plate materials can be attached either to the outdoor or indoor side plate materials, or simply placed in the space between them without attaching them to either.

### BRIEF DESCRIPTION OF FIGURES

FIG. 1: Illustration of Mode of Operation 1

FIG. 2: Exploded view of metal supports

FIG. 3: Expanded view of Mode of Operation 1

FIG. 4: Expansion of (A)-(E)

FIG. 5: Elements of Mode of Operation 2

FIG. 6: Detail drawing of metal supports

FIG. 7: Exploded view of metal supports

FIG. 8: Expanded view of Mode of Operation 2

FIG. 9: Elements of Mode of Operation 3

FIG. 10: Detail drawing of metal supports

FIG. 11: Expanded view of Mode of Operation 3

FIG. 12: Elements of Mode of Operation 4

FIG. 13: Elements of Mode of Operation 5

FIG. 14: Elements of Mode of Operation 6

FIG. 15: Operation of the ventilating structure shown in FIG. 14

FIG. 16: Elements of Mode of Operation 7

FIG. 17: Detail drawing of metal supports.

FIG. 18: Expanded view of Mode of Operation 7

FIG. 19: Elements of Mode of Operation 8

### LEGEND

1 Ventilating structure

3 Outdoor side plate material

5 Indoor side plate material

7 Middle plate material

9 Outdoor supports

11 Indoor supports

13 Middle supports

### POSSIBLE MODES OF OPERATION OF THE INVENTION

Mode of Operation 1

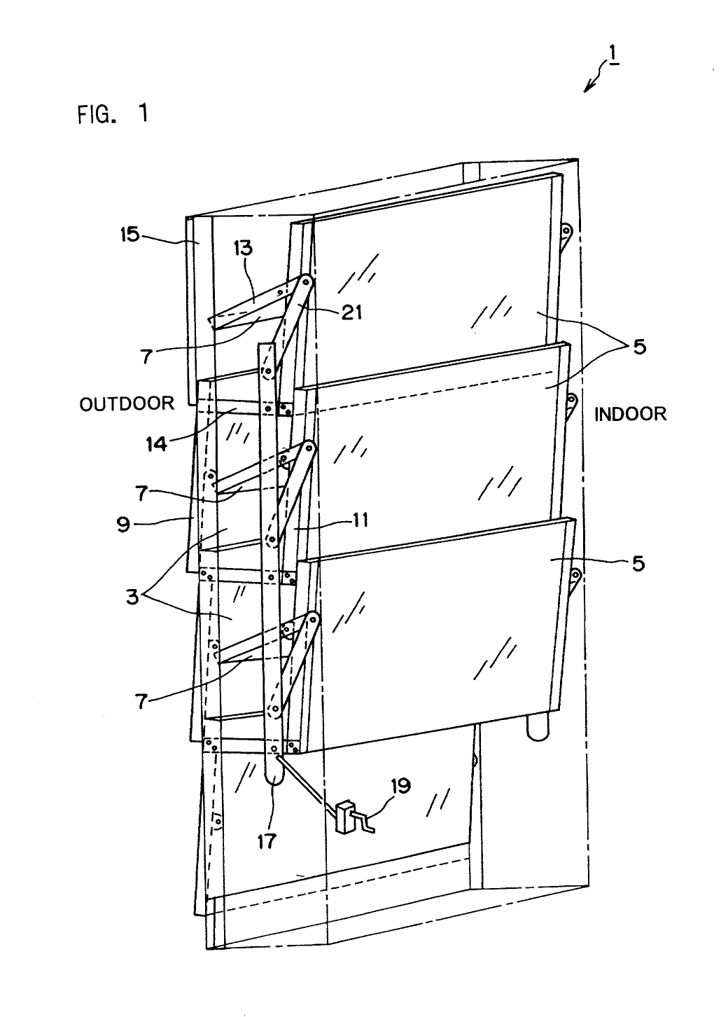

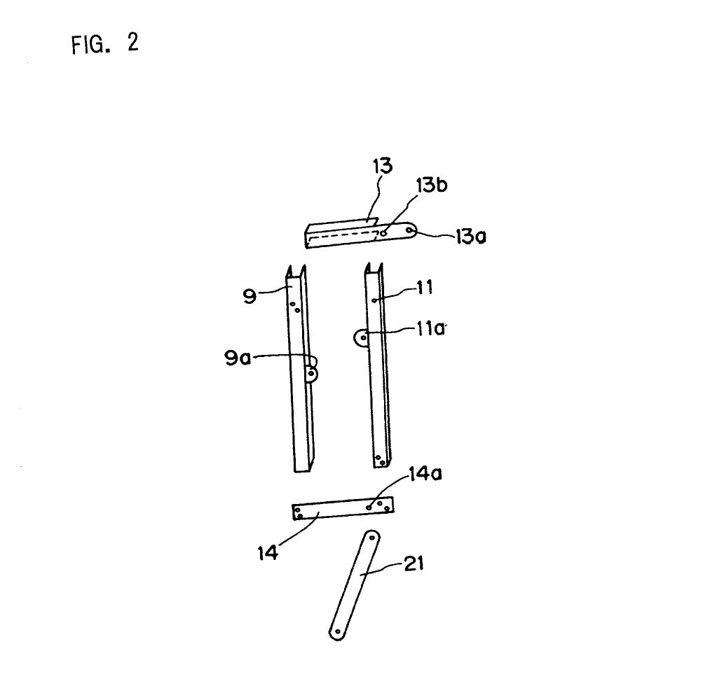

FIGS. 1-3 show one possible mode of operation of the Invention, in which, in the ventilation structure (1) pursuant to the Invention, several outdoor (3) and indoor (5) side plate materials are placed vertically, opposite each other, and intermediate plate material (7) is placed between outdoor side plate material (3) and indoor side plate material (5). Side plate materials (3), (5), and (7) are to be made of either translucent or opaque glass, and their edges are held by 9, 11, and 13, respectively. That is, supports (9), (11), and (13), as can be seen in FIG. 2, have a “ [symbol] ”-shaped cross section, into which both edges of outdoor side plate material (3), indoor side plate material (5), intermediate plate material (7) are each tightly fastened. The supports, as explained below, form a link mechanism, which functions as an opening mechanism to deploy outdoor side plate material (3), indoor side plate material (5), and intermediate plate material (7) to the point of being almost even.

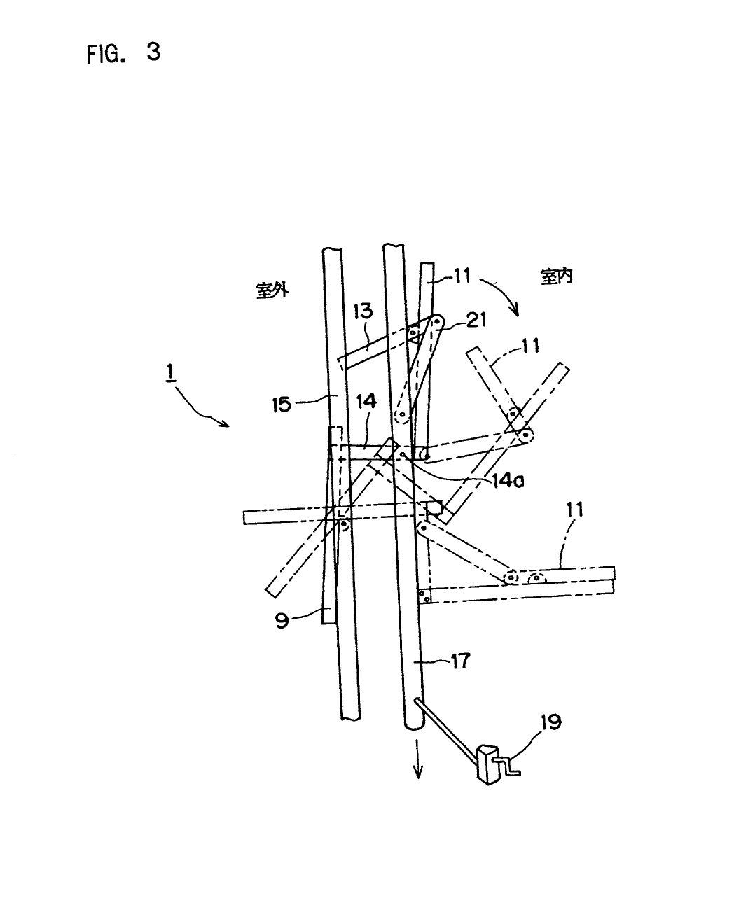

Outdoor support (9) and indoor support (11) are of the same length, and, as shown in FIG. 3, the top edge of outdoor support (9) connects with the bottom edge of indoor support (11) via connector (14). Mount (9a) is located about the centre of outdoor support (9), connected the frame so as to allow it to rotate freely. This allows outdoor support (9) and indoor support (11) to couple and rotate with mount (9a) as the axis of rotation. Coupling hole (14a) is located in connector (14). Bar (17) is connected to coupling hole (14a). When bar (17) is lowered via handle (19), outdoor support (9) and indoor support (11) rotate together, becoming approximately even with each other.

Mount (11a) is located slightly above the centre of indoor support (11), and mount (13a) is located in the edge of middle support (13). Mount (13b) is located at a short distance from mount (13a). Mount (13b) on middle support (13) and mount (11a) on indoor support (11) are connected in such a way as to permit rotation, and mount (13a) is connected to the bar (17) by connector (21). Lowering bar (17) causes mount (13a) on the edge of middle support (13) to be pulled via connector (21) and middle support (13) to rotate on the axis of mount (13b), and becomes approximately even at the point in which the dashed line in FIG. 3 becomes a double-dashed line

The operation of ventilation structure (1) is explained in the following.

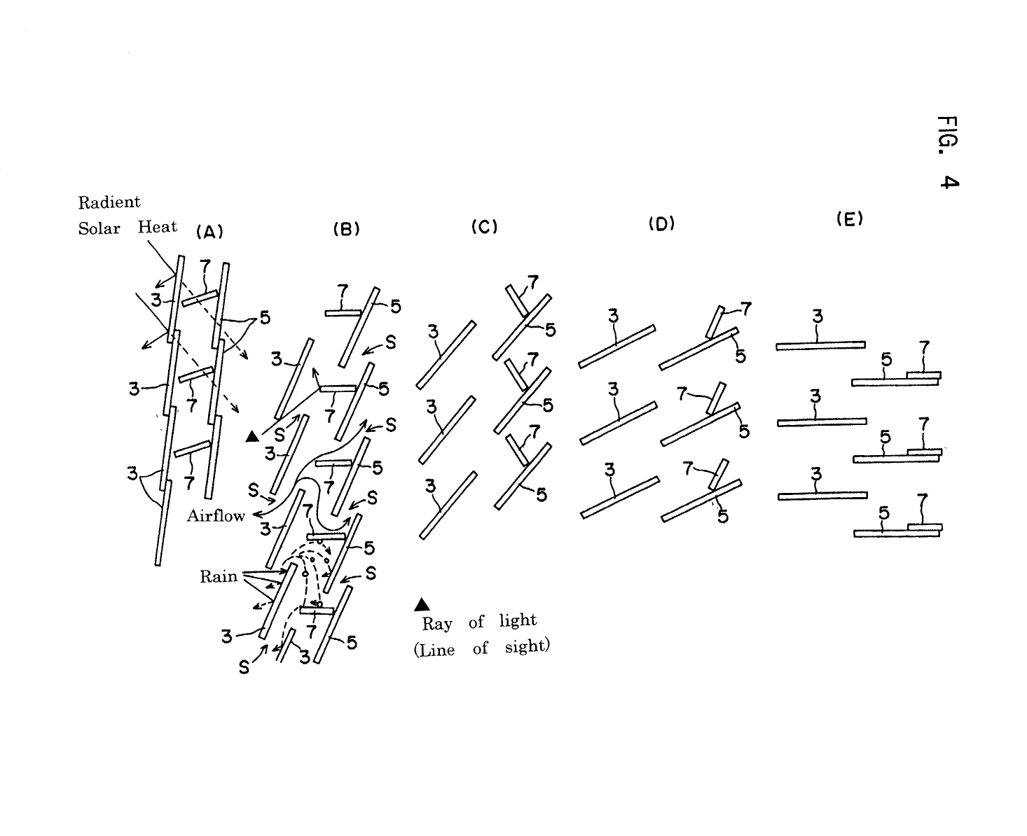

FIG. 4: (A) closed, (B) open, (C) and (D) mid-opening, (E) fully deployed and level. For simplicity, the metal supports and connectors have been omitted from FIG. 4.

Turning handle (19) in the closing direction and raising bar (17) will cause outdoor support (9) and indoor support (11) to move in the closing direction (counter clockwise on FIG. 3), and the adjacent edges of outdoor side plate material (3) and indoor side plate material (5) to connect firmly with each other. The double seal created by the indoor and outdoor side plate materials allows for a higher degree of air tightness. In addition, the insulating effect is increased, as a stratum of air is created between outdoor side plate material (3) and indoor side plate material (5). Furthermore, radiant solar heat can be blocked to a great degree, as outside light must pass through three glass panes—outdoor side plate material (3), intermediate plate material (7), and indoor plate material (5). Moreover, the resultant reduction in energy consumption for heating/cooling significantly increases energy efficiency.

Moving handle (19) in closing direction and lowering bar (17), as shown in FIG. 4 (B), causes outdoor support (9) and indoor support (11) to rotate and outdoor side plate material (3) and indoor side plate material (5) to open, creating ventilation space (S). Outdoor side plate material (3) and indoor side plate material (5) are positioned together traversing ventilation space (S), and, positioned in such a way that, when seen from a level angle, the vertically adjacent edges overlap. Air from both indoors and outdoors circulates via ventilation space (S), optimising airflow.

In addition, intermediate plate material (7) is placed between outdoor side plate material (3) and indoor side plate material (5), so that even if a line of sight (ray of light) from outside were to pass through ventilation space (S), it would be interrupted by intermediate plate material (7) and indoor side plate material (5), and would not be able to pass through the other half of ventilation space (S), thus providing total privacy. That is, not only is the horizontal line of sight blocked; the diagonal view is obstructed both from above and below. It is impossible to see inside even if one comes close to outdoor side plate material (3). Even if one were to leave home with the structure configured as shown in FIG. 4 (B), there need be no concern that someone could look inside.

As shown in FIG. 4 (B), even if rain were to enter through ventilation space (S), it would run into intermediate plate material (7) and indoor side plate material (5), and would not be able to come inside via the other side of ventilation space (S). Thus, normal ventilation is possible even in heavy rains. Middle plate material (7) can be level, but, if slanted slightly downward (towards the outside), rainwater will fall off more easily. Outdoor side plate material (3) and indoor side plate material (5) can both be slanted slightly outward to similar effect.

In this way, a ventilation structure can be created that maintains good airflow and obstructs the view from outside.

As shown in FIGS. 4 (C) and (D), further turning handle (19) causes outdoor and indoor side plate materials (5) and (3) to move further indoors, ultimately becoming almost level, as shown in (E). In this position, the space between the indoor and outdoor side plate materials is at the greatest, allowing for the greatest amount of airflow and natural light. The widening of the space between the side plate materials also facilitates cleaning. By manipulating handle (19) as described above, the degree of airflow and obstruction of view can be adjusted to the user's preference. That is, the closer the structure comes to position (E), the greater the airflow; and the closer to position (A), the more the view from outside is obstructed. Of course, a ventilation structure could be created with side plate materials (5) and (3) and intermediate plate material (7) fixed in the position shown in FIG. 4 (B) so that they could not be repositioned as in (A) and (C) through (E).

Until now, privacy concerns required that bathrooms have high or small windows, resulting in inadequate natural light. However, the ventilation structure pursuant to the Invention is able to obstruct the view from outside, so that windows can be constructed from the floor up, allowing for both a large amount of natural illumination and ventilation, so that dampness and moulds can be removed. In other words, it is possible to maintain privacy, obtain adequate natural illumination, prevent the entry of rain, and allow for natural ventilation, at the same time as providing insulation and air-tightness. As the ventilation structure can be mounted on an existing window, costly installation of a new ventilation system is unnecessary. The Invention can provide a comfortable indoor climate affordably using outdoor air.

Mode of Operation 2

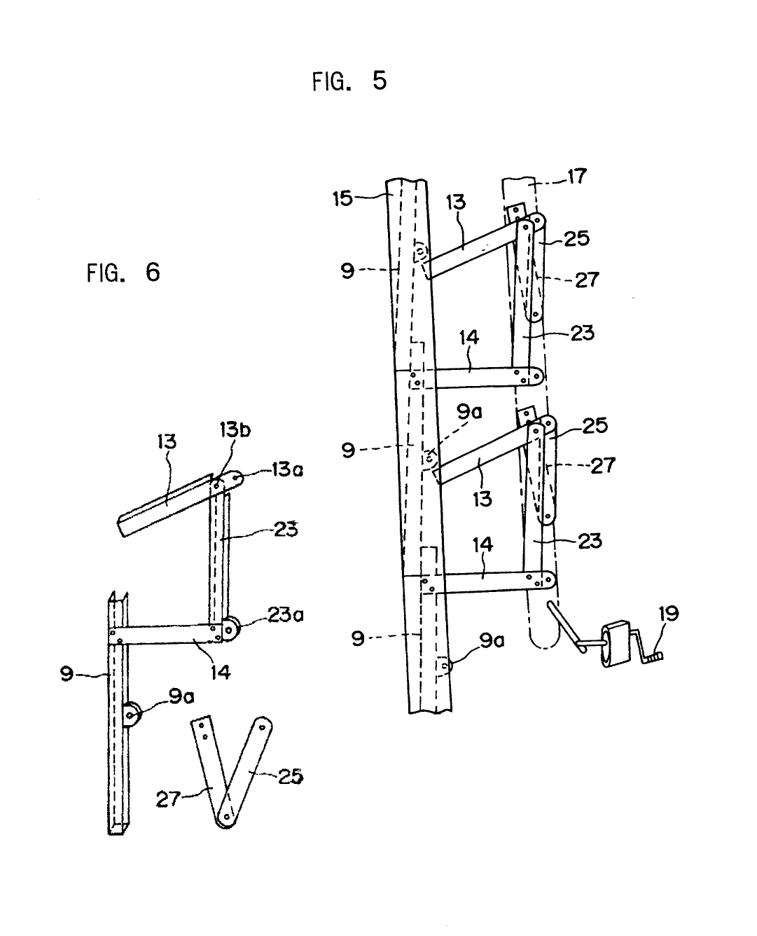

FIGS. 5-8 show the second possible mode of operation. Here, indoor side plate materials (23) are slightly shorter than in the above example, and do not overlap in closed position. The remaining portions are the same as above, and, accordingly, are given the same reference numbers as their counterparts above.

Middle support (13) is mounted on the upper edge of indoor side plate material (23) to allow for ease of opening. Mount (23a), to which bar (17) is supported so as to allow for free rotation, is located on the bottom edge of indoor side plate material (23). Lowering bar (17) causes outdoor side plate material (9) and indoor side plate material (23) to rotate on the axis of mount (9a), and can be deployed to such an extent as to become almost level.

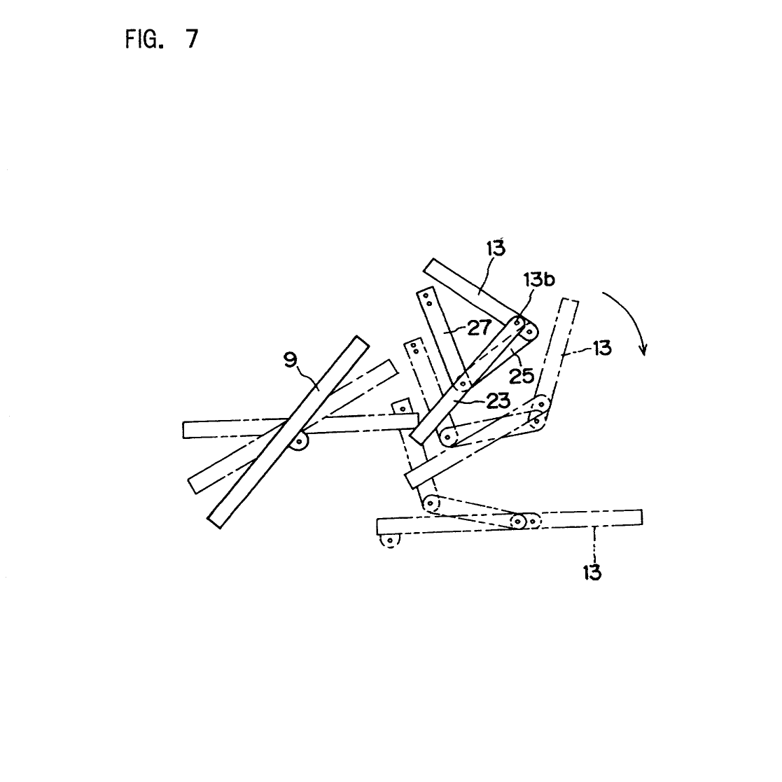

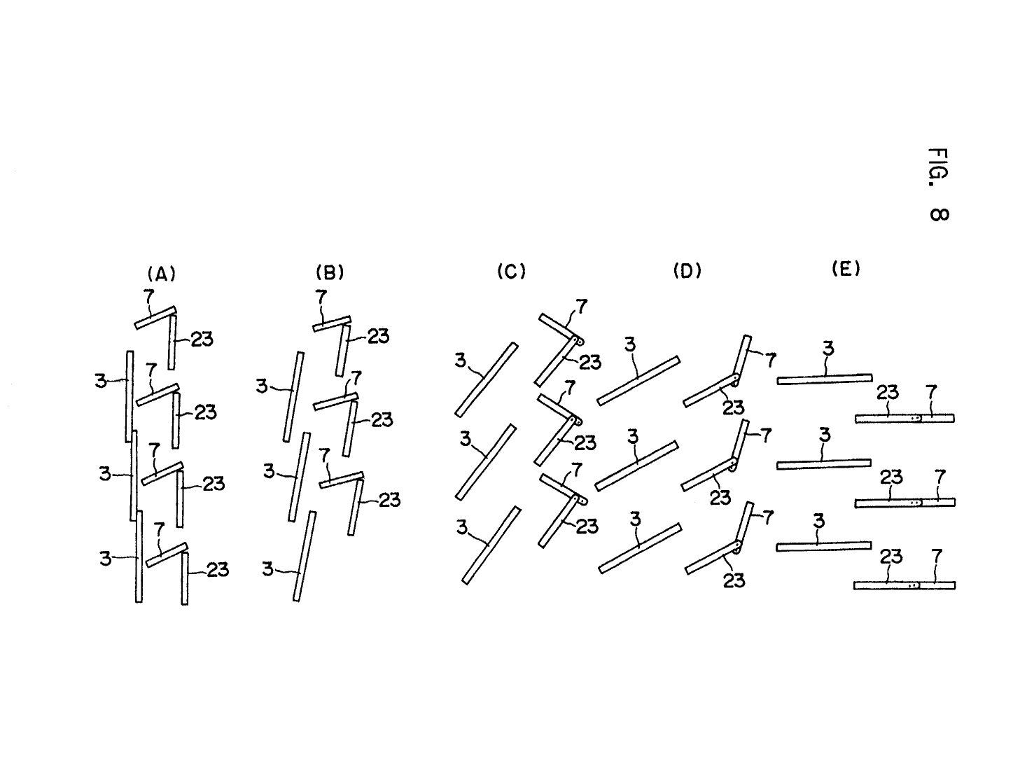

Coupling hole (13a) is located on the edge of middle support (13). The other edge of coupler (25) is coupled to one edge of coupler (27). The other edge of coupler (27) is affixed to bar (17). When bar (17) is lowered, the edge of middle support (13) that contains (13a) is pulled along via coupler (27) and (25), middle support (13) is deployed, rotating on the axis of coupling hole (13b), and the structure becomes roughly level where the single-dotted line in FIG. 7 changes to double-dotted.

FIG. 8 shows the second mode of operation deployed. While substantially similar to FIG. 4, it differs in that indoor side plate material (23) do not overlap when the structure is in closed position. This structure obtains the same results as the foregoing.

Mode of Operation 3

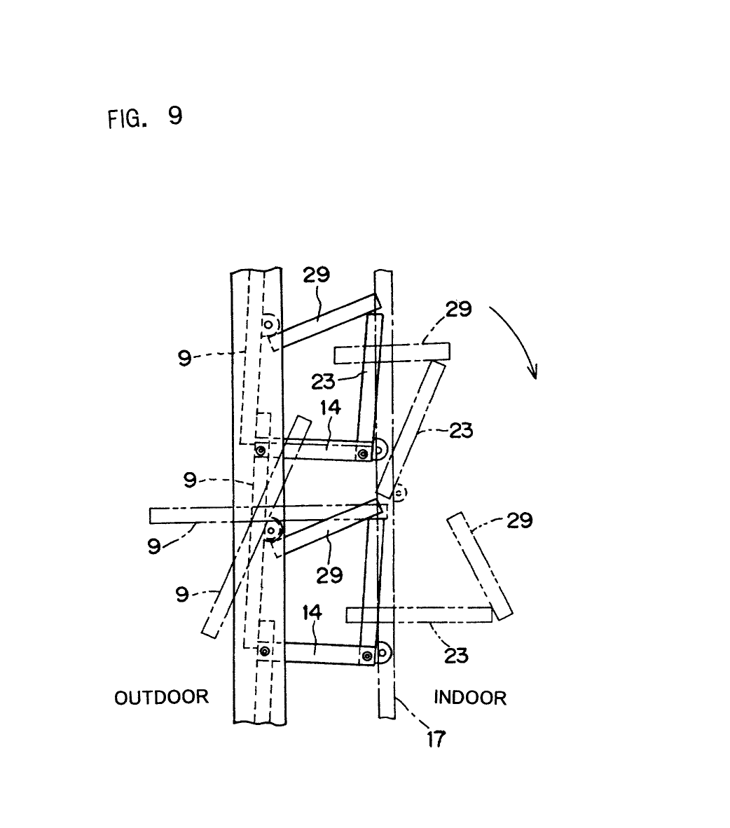

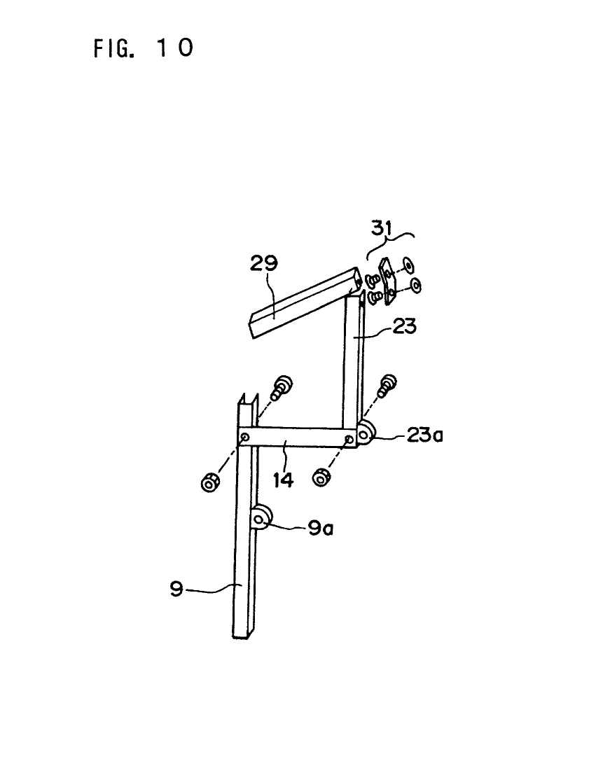

FIGS. 9 through 11 show the third possible mode of operation. This mode differs from Mode 2 in that middle support (29) is affixed to indoor side plate material (23) so that it cannot open. Otherwise, it is identical to Mode of Operation 2.

One edge of middle support (29) is affixed to middle support (23) by support (31). When bar (17) is lowered, outdoor side plate material (9) and indoor side plate material (23) rotate on the axis of mount (9a), and become roughly level where the single-dotted line becomes double-dotted on FIG. 9.

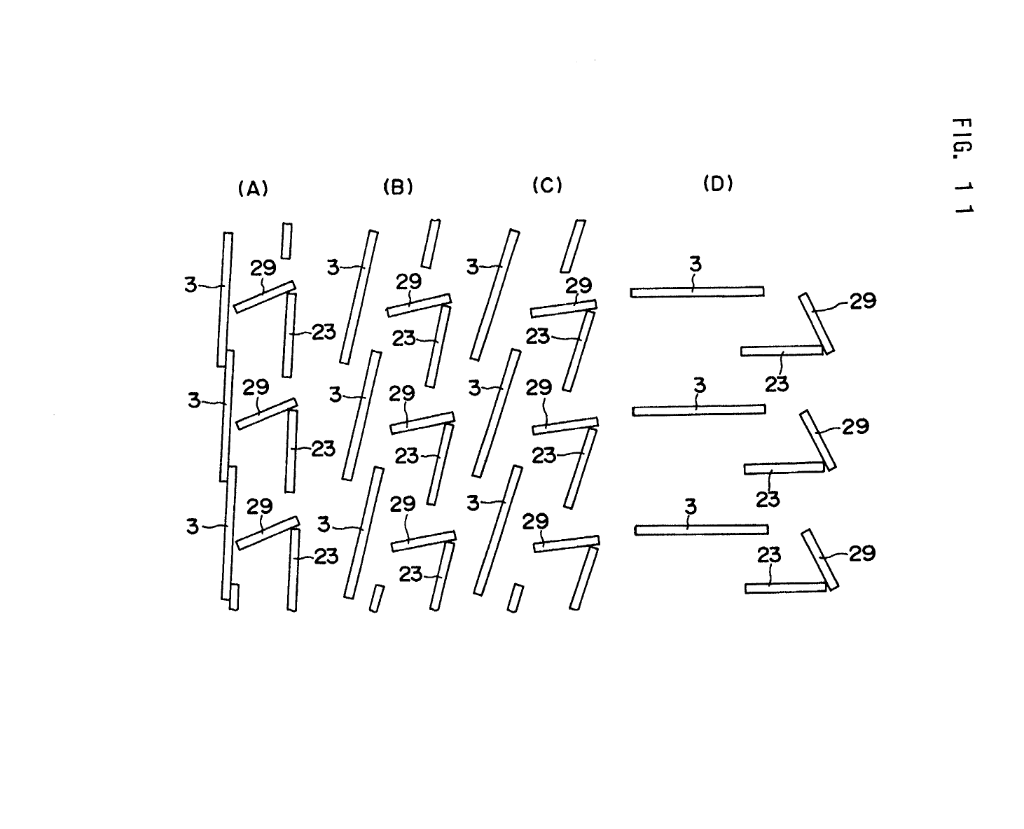

FIG. 11 shows the third possible mode of operation deployed, and is substantially similar to FIG. 4, but differs from FIG. 8 in that intermediate plate material (29) is not deployed in closed position. This ventilation structure obtains the same results as the above modes of operation.

Mode of Operation 4

In the fourth possible mode of operation, all indoor and outdoor side plate materials and intermediate plate materials are fixed. As can be seen in FIG. 12, outdoor supports (33) and (35) are fastened to the frame by screws, etc. outdoor support (33) and outdoor support (35) are positioned alternatingly, and outdoor support (33) is mounted roughly perpendicularly. The upper edge of outdoor support (35) is mounted at an inward slant, and ventilation space (S) is created between the lower edge of outdoor support (33) and the upper edge of outdoor support (35). When seen from a level vantage point, the vertically adjacent edges of outdoor supports (33) and (35) will be seen to overlap.

Indoor support (39) is mounted at the same height as outdoor support (33), and at the positon corresponding to outdoor support (35) no supports are mounted; instead, space (T) is located here. Middle support (43) is mounted on the upper edge of indoor support (39) at a downward slant in the direction of outdoor support (33). Even if rays of light (view) from outside enter via space (S), they will be obstructed by the indoor side plate materials and intermediate plate materials, and will not be able to proceed into space (T). The above structure is similar to FIGS. 4, 8, and 11 (B), and obtains similar results.

Mode of Operation 5

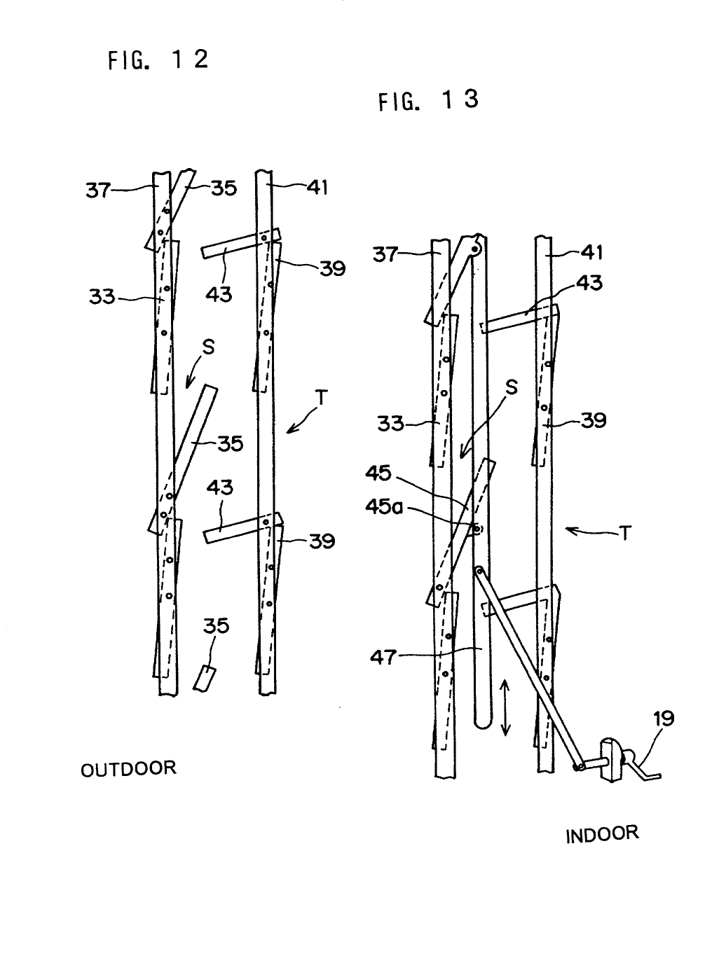

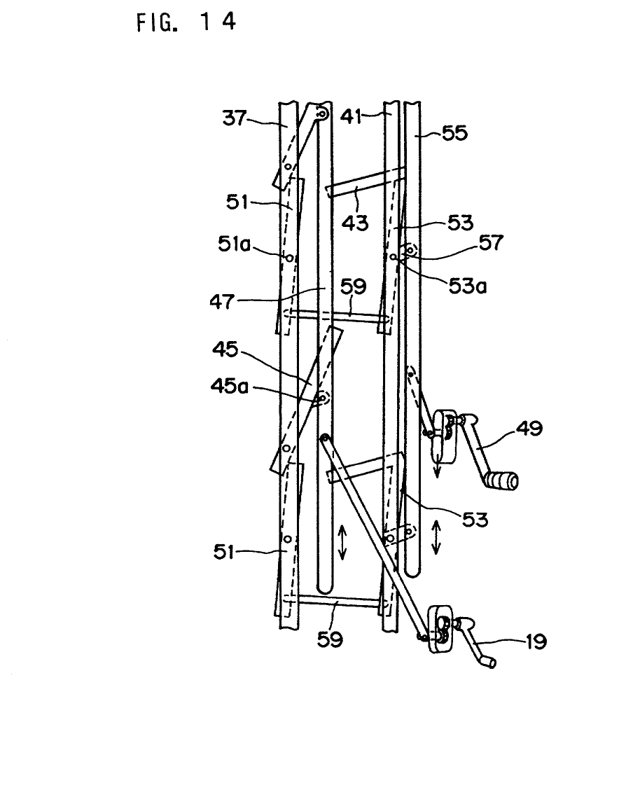

FIG. 13 shows the fifth possible mode of operation, whereby outdoor support (45) that corresponds to outdoor support (35) in FIG. 12, can be opened and closed. That is, one edge of outdoor support (45) is supported in a manner that permits rotation by frame (37), and coupling (45a) fixed on outdoor support (45) is coupled with bar (47), and bar (47) is moved upwards or downwards by handle (19). Other compositions are as in FIG. 12. By rotating handle (19), outdoor support (45) rotates. It is possible to put the structure in the positions shown in FIGS. 4, 8, 11 (A), and 11 (B), and to obtain similar results thereby.

Mode of Operation 6

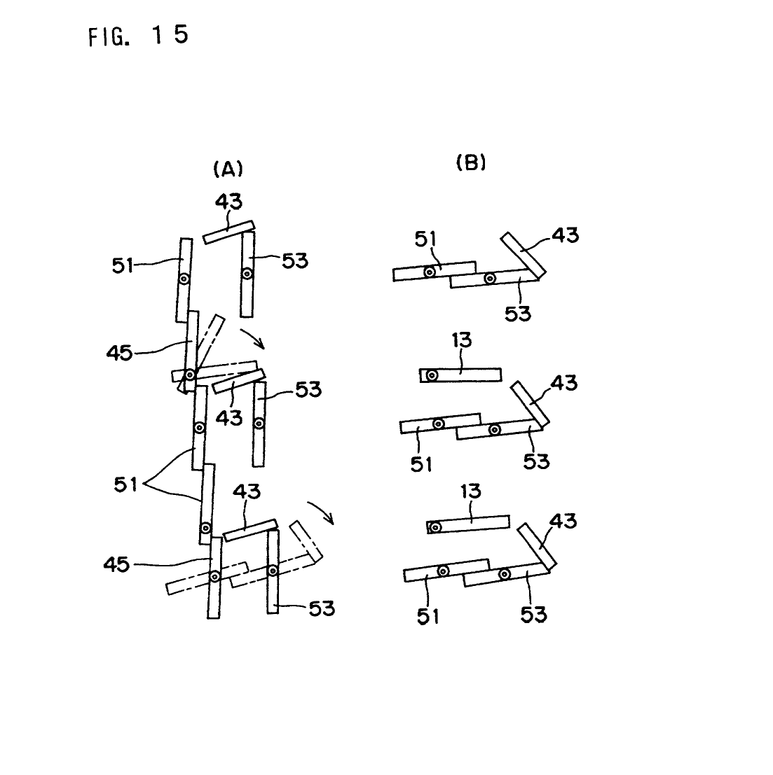

FIG. 14 shows the sixth possible mode of operation, whereby outdoor support (33) and indoor support (39), which were fixed in FIG. 13, are allowed to rotate and deploy. That is, (51a), located approximately at the midpoint of outdoor support (51), is supported in a manner that permits rotation by frame (37), and (53a), located approximately at the midpoint of indoor support (53), is supported in a manner that permits rotation by frame (41), and the lower edge of outdoor support (51) is coupled with the lower edge of indoor support (53) via coupler (59). Indoor support (53) and bar (55) are coupled via coupler (57). When bar (55) is lowered by handle (49), indoor support (53) rotates, and outdoor support (51), which is coupled by indoor support (53) and coupler (59), rotates as well. Outdoor support (51) and indoor support (53) can be deployed until they become almost even.

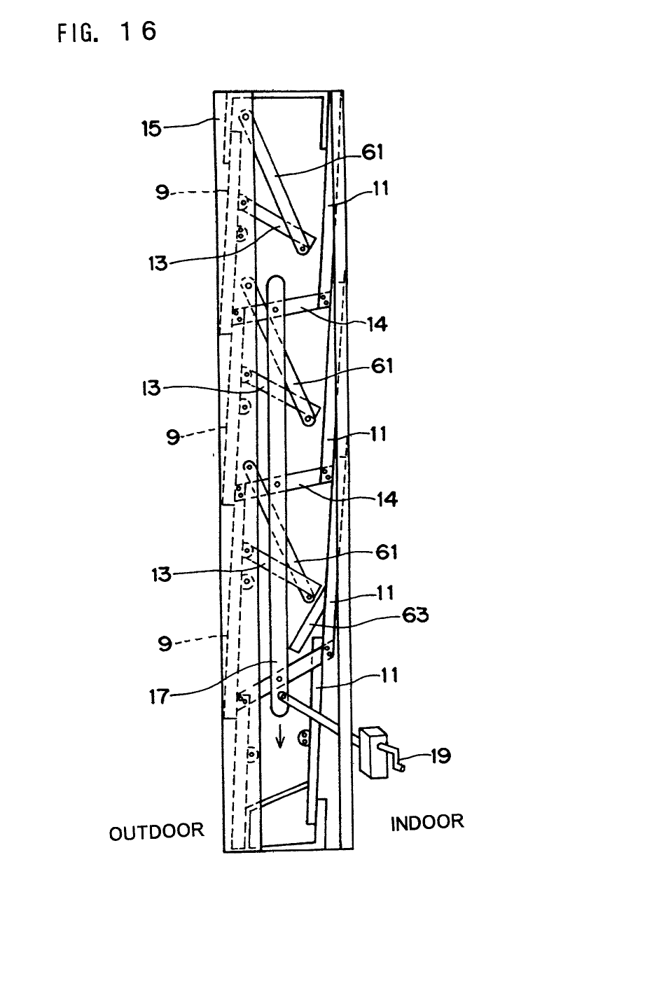

Outdoor support (45) and outdoor support (51) can be activated separately. In other words, as shown in FIG. 15 (A), outdoor support (45) can be deployed alone, and outdoor support (51) and indoor support (53) can be placed even. Shown in FIG. 15 (B) are outdoor supports (45) and (51), and/or middle support (53) both in level position. By rotating handles (19) and (49), it is possible to change the orientation of both outdoor and indoor side plate materials. By opening and closing support (45), it is possible to put the structure in the positions shown in FIGS. 4, 8, 11 (A), and 11 (B), and to obtain similar results thereby.

Mode of Operation 7

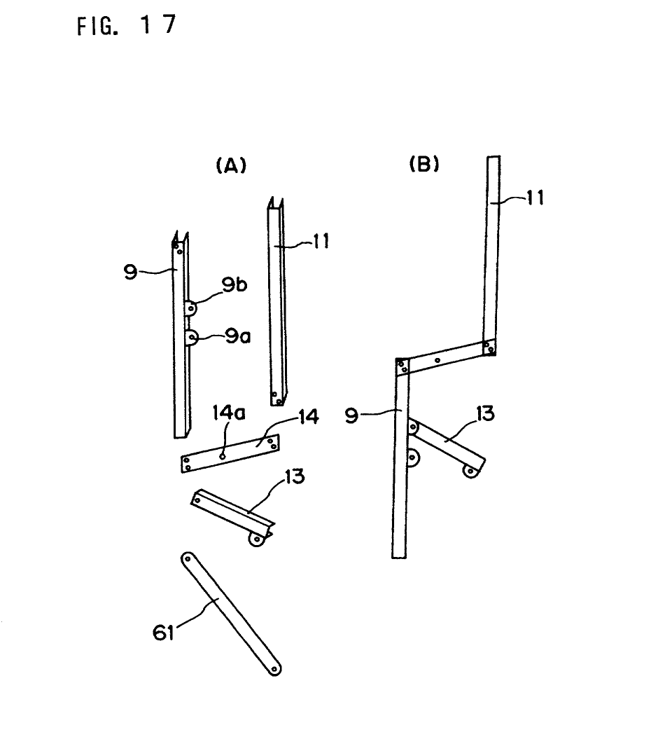

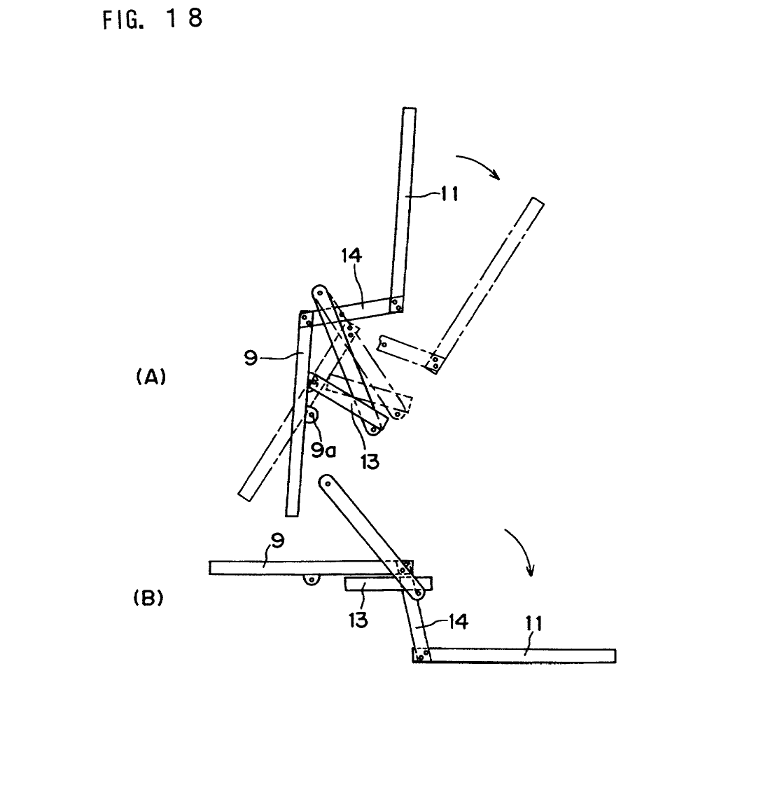

FIGS. 16-18 show possible mode of operation 7. While, in the above examples, the middle supports where mounted on the indoor supports, here, the middle supports are mounted on the outdoor supports. Outdoor and indoor side plate materials, as well as intermediate plate materials, are respectively mounted on supports (9), (11), and (13). They are each fixed. The supports, as shown in FIG. 17, have a “ [symbol] ”-shaped cross section, and the edges of supports (9), (11) and (13) are fastened firmly at this “ [symbol] ”-shaped area.

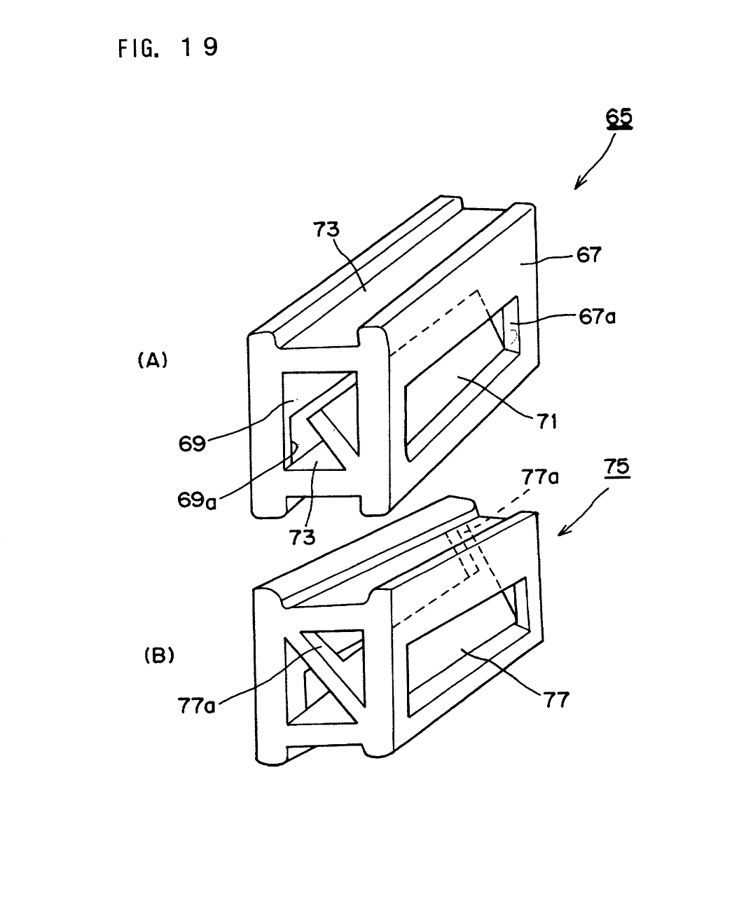

Outdoor support (9) and indoor support (11) are the same length, and, as shown in FIGS. 16 and 18, the upper edge of outdoor support (9) and the lower edge of indoor support (11) are coupled by coupler (14). Mount (9a) is located about the midpoint of outdoor support (9), and outdoor support (9) is mounted on the main frame (15) at mount (9a). This unites outdoor support (9) and indoor support (11), and they rotate on the axis of mount (9a). Coupling hole (14a) is located on coupling (14). Bar (17) is mounted in coupling hole (14a), and, when lowered by bar (17) and handle (19), as shown in FIG. 18 (B), outdoor support (9) and indoor support (11) rotate together and become almost even.

Slightly above mount (9a) on outdoor support (9), mount (9b) is located, where one of the edges of middle support (13) is mounted. The other edge of intermediate plate material (13) is coupled with frame (15) via coupling (61). When bar (17) is lowered, the edge of middle support (13) coupling (61) will be pulled along, and middle support (13) will rotate upward (counter clockwise in figure), as shown in FIG. 18 (A), ultimately becoming even as shown in FIG. 18 (B). Plate (63) in FIG. 16 blocks rain from coming inside.

According to the above structure, turning bar (17) makes it possible to deploy the structure as in FIGS. 4, 8, and 11 (with the exception that the intermediate plate material touches the outdoor side plate material), and obtains similar results.

Mode of Operation 8

FIG. 19 shows the Invention used on building blocks. Building block (65) has walls 1 (67) and 2 (69), which face each other. Walls 1 (67) and 2 (69) have a ventilation opening (69a), (67a) respectively. Between openings (67a) and (69a) is obstructing wall (7 1), and central wall (73) is located between walls (67) and (69). Obstructing wail (7 1) is at an approximately 45° slant, and its height is designed such that light entering through either opening (67a) or (69a) cannot continue through to the other opening (69a) or (67a).

By creating a wall with the above blocks, it is possible to create a ventilation structure that can maintain airflow and protect privacy. In this case, wall 1 (67) is located outside.

Block (75) shown in FIG. 19 (B) has both edges of obstructing wall (7 1) reinforced by coupling support (77a) with wall 2 (69). Other compositions are as in (A), block (65).

The mechanisms that can be created using the above supports are not limited to the foregoing examples, and can be used for mechanisms of any other type, i.e. the side plate materials can be opened and closed, or the outdoor and indoor side plate materials and intermediate plate material can be deployed to the point of being level. The outdoor and indoor side plate materials and the intermediate plate materials need not be made of glass; wood would be acceptable. Nor do any limitations exist with respect to colour or material quality. Furthermore, these can be supported using the aforementioned supports, but this not necessary, as the outdoor and indoor side plate materials and the intermediate plate materials can be mounted directly to the main frame. As stated above, the Invention makes it possible to maintain airflow while protecting privacy.

### POTENTIAL FOR COMMERCIAL USE

The aforementioned ventilation structure can be used for building windows, doors, walls, shutters, vehicle windows, block building materials, helmets, and other locations in which ventilation and privacy are necessary.

1. A ventilation structure that places several indoor and outdoor side plate materials opposite each other, vertically traversing the ventilation space, with intermediate plate materials placed between the outdoor and indoor side plate materials; which structure is designed so that a ray of light from one ventilation space will be interrupted by either the indoor side plate material or the intermediate plate material, and not pass through to the other ventilation space.

2. The structure described in claim 1, characterised by the ability to open and close the indoor and outdoor side plate materials.

3. The structure described in claim 1 or 2, characterised by an opening mechanism that allows for the deployment of the outdoor and indoor side plate materials and intermediate plate material until they become almost even.

4. The structure described in claim 3, characterised by the fact that the opening mechanism is a link mechanism coupled with the aforementioned outdoor and indoor side plate materials or intermediate plate materials.

5. A ventilation structure with two walls, (1) and (2) facing each other, each of which has a ventilation opening, between which walls an obstructing wall is present, such that light coming from one side will be obstructed by wall (1) or (2) or the obstructing wall, and will not allow incoming light to pass through to the other side.
